(19) United States
(12) Patent Application Publication
(10) Pub. No.: US 2016/0239107 A1
(43) Pub. Date: Aug. 18, 2016

(54) Method, Touch Sensitive Electronics, and System for Adjusting Pressure Signal Parameter of Stylus

(71) Applicant: EGALAX_EMPIA TECHNOLOGY INC., Taipei City (TW)

(72) Inventor: SHANG-TAI YEH, TAIPEI CITY (TW)

(21) Appl. No.: 15/016,788

(22) Filed: Feb. 5, 2016

Related U.S. Application Data
(60) Provisional application No. 62/115,957, filed on Feb. 13, 2015.

(51) Int. Cl. G06F 3/038; G06F 3/041; G06F 3/0354

(52) U.S. Cl. CPC G06F 3/0383; G06F 3/03545; G06F 3/0414; G06F 3/0416

(57) ABSTRACT

The present invention provides a method for adjusting pressure signal parameter of stylus. The method includes receiving multiple pressure signal values with regard to a stylus; determining a lower bound value of a pressure signal value interval with regard to the stylus according to the pressure signal values; and determining an upper bound value of the pressure signal value interval according to the pressure signal values.

### CROSS REFERENCE TO RELATED APPLICATIONS

This application claims priority to U.S. patent application, 62/115,957, filed on Feb. 13, 2015, the disclosure of which is incorporated herein by reference.

### BACKGROUND OF THE INVENTION

1. Field of the Invention

The present invention relates to a stylus, and more particularly, to a method for adjusting pressure signal value related to the stylus.

2. Description of the Prior Art

Using a stylus to write or paint on the touch panel has become one of trends in the future. In order to mimic the brush strokes of Chinese writing brushes or water-color brushes, many commercially available styluses are equipped with the function of detecting pressure. Namely, they can detect the pressure strength of the styluses touching the surfaces of the screens and then transmit the detected pressure signals to the touch panel. By doing so, the changes of the users' writing force make the lines shown on the touch panels correspondingly presented the changes of the writing effects of the strokes weights or styles.

The above-mentioned pressure signal value is usually transmitted to the touch panel in the digital value, such as degree of 256 levels, 512 levels, or 1024 levels, etc. Besides transmitting the signals back in the digital value, it is possible to use analog signals to send them back to the touch panel and then the analog signals are converted into the digital signals, represented by the above-mentioned degree of 256 levels, 512 levels, or 1024 levels. In other words, the converting process from the analog signals to the digital signals can be processed on the stylus, or it can be handled on the touch panel. The above-mentioned pressure signal values can be received by the touch panel or by the electronic devices equipped with touch panel.

However, as for the stylus that can detect touch pressure, the manufacturing tolerance of the stylus itself enables the touch panel to cause the differently detected pressure values when two different styluses are applied. For example, assumed two different styluses are used to write on the same touch panel by the same pressure, the shown stroke weights on the touch panel may be different due to the manufacturing tolerances. Therefore, it is a difficult task how to accurately correspond and then change the shown writing effects of the touch panel based on the actual pressure strength of the touch of the stylus.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

One aspect of the present invention is to provide a method for adjusting pressure signal parameter of stylus. The method includes receiving multiple pressure signal values with regard to a stylus, determining a lower bound value of a pressure signal value interval with regard to the stylus according to the pressure signal values, and determining an upper bound value of the pressure signal value interval according to the pressure signal values.

One aspect of the present invention is to provide a touch sensitive electronics for adjusting pressure signal parameter of stylus. The touch sensitive electronics includes a receiving interface used to receive multiple pressure signal values with regard to a stylus, and a processor used to determine a lower bound value of a pressure signal value interval with regard to the stylus according to the pressure signal values, and determine an upper bound value of the pressure signal value interval according to the pressure signal values.

One aspect of the present invention is to provide a touch sensitive electronic system. The touch sensitive electronic system includes a stylus used to generate multiple pressure signal values, and a touch sensitive electronics. The touch sensitive electronics includes a receiving interface used to receive the pressure signal values, and a processor used to determine a lower bound value of a pressure signal value interval with regard to the stylus according to the pressure signal values, and determine an upper bound value of the pressure signal value interval according to the pressure signal values.

According to the method, the touch sensitive electronics, and the system for adjusting pressure signal parameter of stylus offered by each embodiment in the present invention, the pressure signal value interval related to individual stylus can be set up. According to the pressure signal value interval and standard pressure interval, a modified function can be produced. By corresponding to the modified function of individual stylus and based on the actual pressure strength of the stylus, the modified pressure value can be precisely generated to change the writing effects displayed on the touch sensitive screen.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 illustrates a schematic diagram of a touch sensitive electronic system in accordance with an embodiment of the present invention;

FIG. 2 illustrates a schematic diagram of a touch sensitive electronic system in accordance with an embodiment of the present invention;

FIG. 3 shows a flow chart of a method for adjusting pressure signal parameter related to a stylus in accordance with an embodiment of the present invention;

FIG. 4 illustrates a diagram for function corresponding in accordance with an embodiment of the present invention; and

FIG. 5 shows a flow chart of a method for correcting pressure value in accordance with an embodiment of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

The present invention provides a method for getting the maximum and minimum of pressure values with regard to a stylus in advance to correct the writing effects displayed on a touch screen. The method includes the following procedures that are carried out in advance when a stylus is used on the touch panel: enabling the touch panel to offer at least one detecting period in order to provide user to use the stylus to write on the touch panel within the detecting period; continuously detecting the signals transmitted by the stylus within the detecting period by the touch panel; determining the represented pressure values of the detected signals, getting a maximum and a minimum values from the pressure values, calculating the difference value between the maximum and minimum values, and saving the difference value to represent the pressure range when the user uses the stylus to touch the touch panel. By doing so, when the touch panel used in the real situation receives an actual pressure value and compares the actual pressure value and the pressure range, the writing effects can be presented based on the ratio of the actual pressure value and the pressure range.

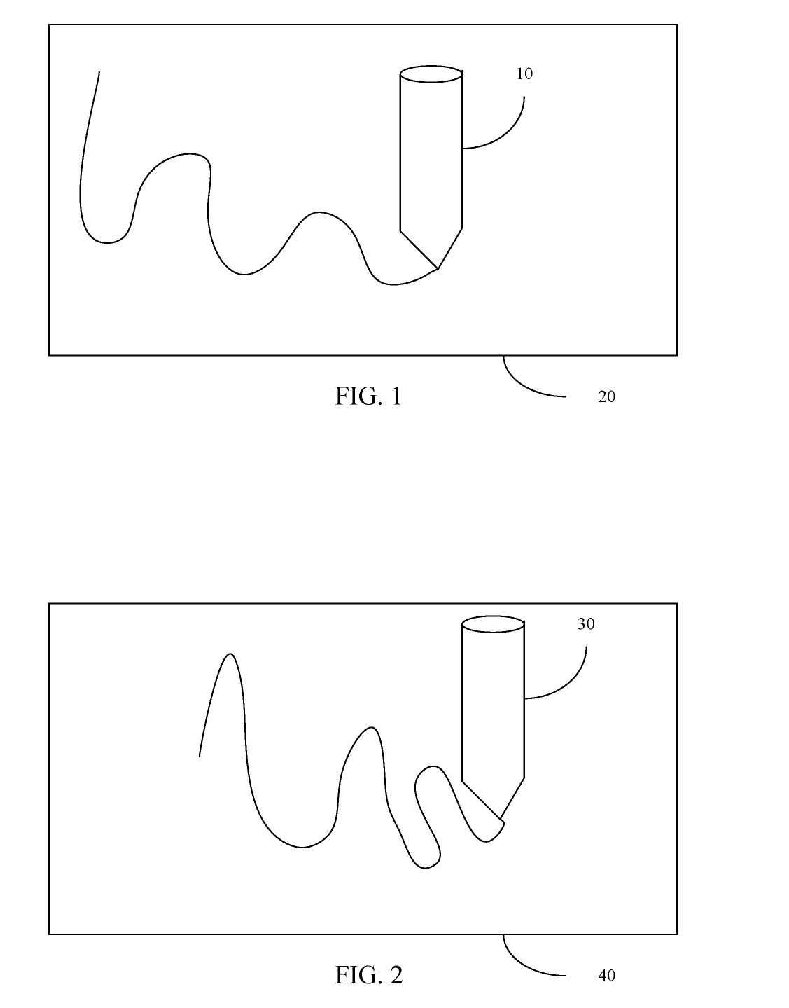

Referring to FIG. 1, a schematic diagram of a touch sensitive electronic system in accordance with an embodiment of the present invention is illustrated. A stylus 10 is applied on a touch panel 20, such as using the stylus on the touch panel for the first time, or not using it for a long time and then using it again on the touch panel. The touch panel 20 is, for example, a capacitive touch panel, but not limit to. The following steps are carried out in the present embodiment. First, one prompting word or picture can be shown on the touch panel 20 to hint user to try drawing something on the touch panel 20. Also, one detecting period is offered. Within the detecting period, the drawings drawn on the touch panel 20 by the user holding the stylus 10 are detected by the touch panel 20. As shown in FIG. 1, the forms of drawing lines are not limited. They can be straight lines, curved or arbitrary ones. The number of them is not limited either. They can be continuous ones or many different strokes. The touch panel 20 can continuously detect the signals transmitted by the stylus 10 when the stylus 10 is used on the touch panel 20 within the detecting period. After the touch panel 20 receives the signals, it determines the represented pressure values respectively of the detected signals. Also, the maximum and minimum values of the pressure values are gained and the difference value between the maximum and minimum values is saved, which represents the pressure range that the user uses the stylus 10 to touch on the touch panel 20. By doing so, when the touch panel 20 used in the real situation receives the signals from the stylus 10 and determines it as a pressure value, the pressure value and the pressure range are compared, and the writing effects can be presented based on the ratio of the pressure value and the pressure range. For example, when the received pressure value is larger, the writing effect shown on the touch panel 20 is also larger. For example, the stroke weights are shown thicker or heavier. Similarly, when the received pressure value is smaller, the writing effect shown on the touch panel 20 is also smaller. For example, the stroke weights are shown thinner or lighter.

Referring to FIG. 2, a schematic diagram of a touch sensitive electronic system in accordance with an embodiment of the present invention is illustrated. A stylus 30 is applied on a touch panel 40, such as using the stylus on the touch panel for the first time, or not using it for a long time and then using it again on the touch panel. The touch panel 40 is, for example, a capacitive touch panel, but not limit to. The following steps are carried out in the present embodiment. First, a first prompting word or picture can be shown on the touch panel 40 to hint user to try drawing something on the touch panel 40 for the first time. Also, a first detecting period is offered. Within the detecting period, the first drawings drawn on the touch panel 40 by the user holding the stylus are detected, and the drawing force is inclined to be bigger. The forms of drawing lines are not limited. They can be straight lines, curved or arbitrary ones. The number of then is not limited either. They can be one continuous line or many different strokes. The touch panel 40 can continuously detect the signals transmitted by the stylus 30 when the stylus 30 is used on the surface of the touch panel 40 for the first tested drawing within the detecting period. After the touch panel 40 receives the signals of the first tested drawing, it determines the represented pressure values respectively of the received signals and gets the maximum value of the pressure values and then saves it.

Next, a second prompting word or picture can be shown on the touch panel 40 to hint the user to try drawing something on the touch panel 40 for the second time. Also, a second detecting period is offered. Within the second detecting period, the second drawings drawn on the touch panel 40 by the users holding the stylus 30 are detected, and the drawing force is inclined to be lighter. The forms of drawing lines are not limited. They can be straight lines, curved or arbitrary ones. The number of them is not limited either. They can be one continuous line or many different strokes. The touch panel 40 can continuously detect the signals transmitted by the stylus 30 when the stylus 30 is used on the surface of the touch panel 40 for the second tested drawing within the detecting period. After the touch panel 40 receives the signals of the second tested drawing, it determines the represented pressure values respectively of the received signals and gets the minimum value of the pressure values and then saves it.

Then, the difference value between the maximum and minimum values is gained, which represents the pressure range that the user uses the stylus 30 to touch on the touch panel 40. By doing so, when the touch panel 40 used in the real situation receives the signals from the stylus 30 and determines it as a pressure value, the pressure value and the pressure range are compared, and the writing effects can be presented based on the ratio of the pressure value and the pressure range. For example, when the received pressure value is larger, the writing effect shown on the touch panel 40 is also larger. For example, the stroke weights are shown thicker or heavier. Similarly, when the received pressure value is smaller, the writing effect shown on the touch panel 40 is also smaller. For example, the stroke weights are shown thinner or lighter.

In another embodiment, it is similar to the embodiment of FIG. 2. The difference is: in the present embodiment, an average of the pressure values from various points of the first tested drawing is recorded as a first average. Also, an average of the pressure values from various points of the second tested drawing is recorded as a second average. After that, the difference value between the maximum and minimum values is gained, which represents the pressure range that the user uses the stylus to touch on the touch panel. By doing so, when the touch panel used in the real situation receives the signals from the stylus and determines it as a pressure value, the pressure value and the pressure range are compared, and the writing effects can be presented based on the ratio of the pressure value and the pressure range. For example, when the received pressure value is larger, the writing effect shown on the touch panel is also larger. For example, the stroke weights are shown thicker or heavier. Similarly, when the received pressure value is smaller, the writing effect shown on the touch panel is also smaller. For example, the stroke weights are shown thinner or lighter.

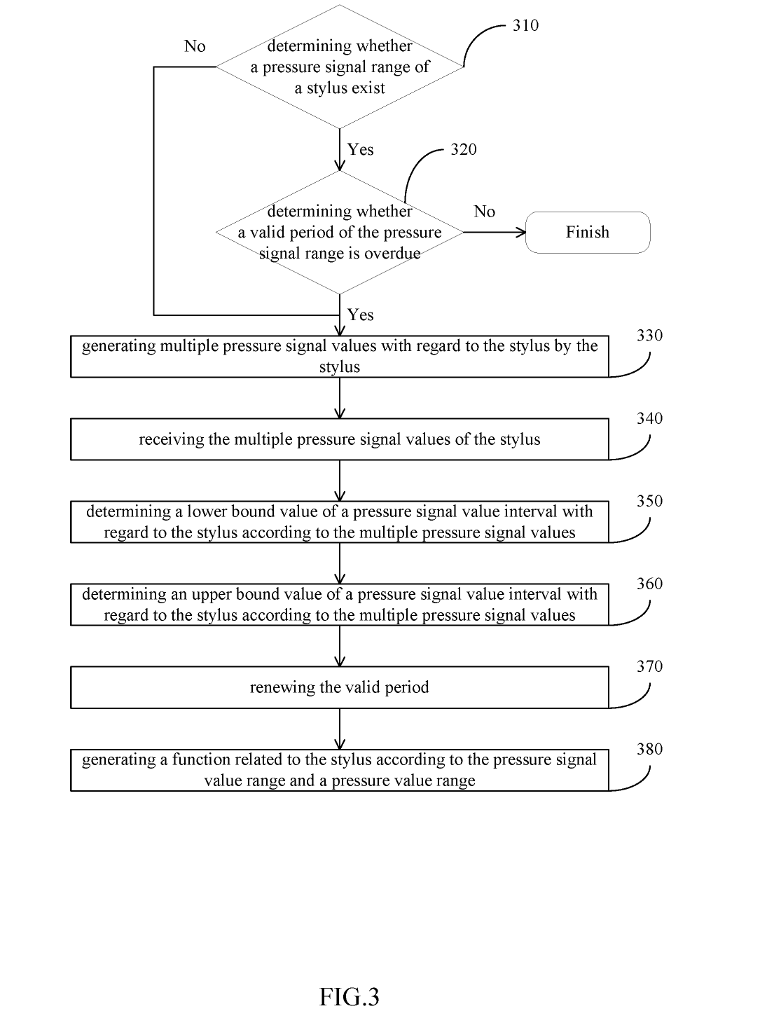

Referring to FIG. 3, a flow chart of a method for adjusting pressure signal parameter related to a stylus in accordance with an embodiment of the present invention is illustrated. Some steps of the method can be applied to a stylus, and they can also implement on a touch sensitive electronics that coordinates with the stylus. When making use of the touch sensitive electronics to implement the steps, the central process unit of the touch sensitive electronics and the chip controlling the touch panel can be used. If the causal connection of each step is not explained, the invention does not limit the sequential order of the implementation of each step and each one may not always be necessary or cannot be omitted. Other unexplained steps can be inserted between each procedure.

In step 310, determining whether a pressure signal range of a stylus exist. In this step, the touch sensitive electronics may identify individual stylus. For instance, it can identify the stylus based on, such as the frequency, modulated ways, and etc., of the electric signals transmitted by the tip section of the stylus. It can also identify the stylus by the Bluetooth coding inside the stylus. The present invention is not limited to how to identify the stylus. When the data of the pressure signal range of the stylus cannot be found, the step 330 is performed. In one embodiment, when the data of the pressure signal range of the stylus is found, the step ends directly. In this embodiment, the pressure signal range doesn't have related valid period, it is permanent. However, in another embodiment, when the data of the pressure signal range of the stylus is found, the step 320 is performed.

In step 320, determining whether a valid period of the pressure signal range is overdue. When it is not expired, the step ends directly, otherwise the step 310 is launched.

In step 330, generating multiple pressure signal values with regard to the stylus by the stylus. As mentioned above, when the tip section of the stylus touches the touch panel, the pressure signal values of the stylus are produced. These values can be analog signals or digital signals. The present invention is not limited to the forms of the signals.

In step 340, receiving the multiple pressure signal values of the stylus. As mentioned above, the electric signals transmitted by the tip section of the stylus enable the touch panel to demodulate the electric signals to get the pressure signal values of the stylus. Or, the stylus can enable the touch sensitive electronics to get the pressure signal values of the stylus through wire or wireless connection. It is noticeable the steps 330 and 340 could be implemented repeatedly. For example, when a first pressure signal value of the stylus is produced by making use of the stylus, the first pressure signal value of the stylus is received. Then, when a second pressure signal value of the stylus is produced by making use of the stylus, the second pressure signal value of the stylus is received, and so on. It does not need to wait the production of the multiple pressure signal values of the stylus and then receive them.

In step 350, determining a lower bound value of a pressure signal value interval with regard to the stylus according to the multiple pressure signal values. There are several ways to implement step 350. As the first above-mentioned embodiment, the lower bound value is the minimum value of the multiple pressure signal values of the stylus. As the second above-mentioned embodiment, the lower bound value is the minimum value of the multiple pressure signal values of the stylus within the first detecting period. As the third above-mentioned embodiment, the lower bound value is the average of the multiple pressure signal values of the stylus within the first detecting period. In the latter two embodiments, step 350 further includes prompting the user using the stylus before the first detecting period.

In step 360, determining an upper bound value of a pressure signal value interval with regard to the stylus according to the multiple pressure signal values. There are several ways to implement step 360. As the first above-mentioned embodiment, the upper bound value is the maximum value of the multiple pressure signal values of the stylus. As the second above-mentioned embodiment, the upper bound value is the maximum value of the multiple pressure signal values of the stylus within the second detecting period. As the third above-mentioned embodiment, the upper bound value is the average of the multiple pressure signal values of the stylus within the second detecting period. In the latter two embodiments, step 360 includes prompting the user using the stylus before the second detecting period. The first detecting period and the second detecting period are different periods. The present invention is not limited to the sequential order of them.

In step 370, renewing the valid period. When the pressure signal range has a corresponding valid period, this step can be implemented.

In step 380, generating a function related to the stylus according to the pressure signal value range and a pressure value range.

In the present invention, the implemented orders of the steps 350, 360, and 370 are not limited.

In one embodiment of the present invention, when the method mentioned above wants to generate the function in step 380, the step 310 can be switched to determine if the function related to the stylus exists. When the function does not exist, the steps 330, 340, 350, 360, and 380 will be implemented. When the function exists, the method ends.

In another embodiment, when the function exists, the variation of the step 320 can be implemented to determine whether a valid period is overdue. When it is overdue, the steps 330, 340, 350, 360, 370, and 380 will be implemented. When the function exists and is not overdue, the method ends.

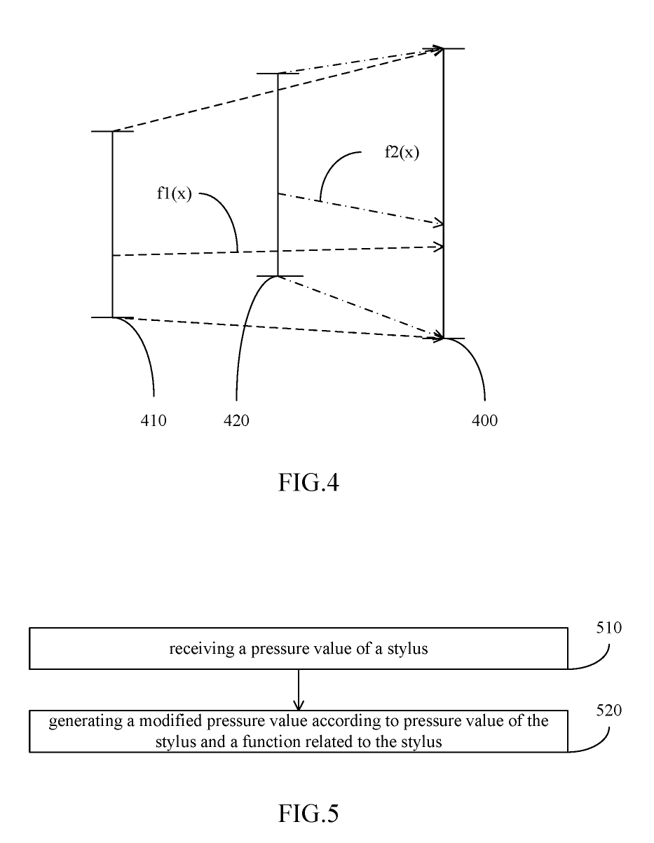

Referring to FIG. 4, a diagram for function corresponding in accordance with an embodiment of the present invention is illustrated. In FIG. 4, three ranges exist. A first pressure signal range 410 corresponds to a first stylus. A second pressure signal range 420 corresponds to a second stylus. A standard range 400 is a standard pressure signal range that application programs or operating system use, such as the above-mentioned 256 levels, 512 levels and 1024 levels. When the standard range 400 is 1024 levels, the lower bound value is 0 and the upper bound value is 1023, or from 1 to 1024, etc.

Since the technologically manufacturing differences mentioned previously or other environmental causes such as temperature or humidity, the upper and lower bounds of the first and the second pressure signal ranges 410 and 420 respectively corresponding to the first and the second styluses are different. However, the lower bound value is higher than or equals to that of the standard range 400. The upper bound value is lower than or equals to that of the standard range 400. Therefore, as shown in FIG. 3, the step 380 uses a first function f1(x) to change one pressure value in the first pressure signal range 410 into a modified pressure value in the standard range 400. Similarly, it also uses a second function f2(x) to change one pressure value in the second pressure signal range 420 into a modified pressure value in the standard range 400.

It is clearly understandable that when the upper and lower bounds of the first pressure signal range 410 and the second pressure signal range 420 are different, the same pressure signal value through different first function f1(x) and second function f2(x) will get different modified pressure value. On the contrary, the same modified pressure value corresponding to different inverse function of f1(x) and inverse function of f2(x) will get different original pressure signal values.

According to the first pressure signal range 410 and the standard range 400, the first function f1(x) will be gotten. Similarly, according to the second pressure signal range 420 and the standard range 400, the second function f2(x) will be gotten. Therefore, whether the pressure signal range or the function is recorded, the meaning is all the same. The present invention can be applied to record the pressure signal range or the function.

Referring to FIG. 5, a flow chart of a method for correcting pressure value in accordance with an embodiment of the present invention. Some steps of the flow chart can apply to a stylus and can also implement on a touch sensitive electronics that coordinates with a stylus. When making use of the touch sensitive electronics to implement the steps, the central process unit of the touch sensitive electronics and the chip controlling the touch panel can be used.

In step 510, receiving a pressure value of a stylus.

In step 520, generating a modified pressure value according to pressure value of the stylus and a function related to the stylus. In one embodiment, the step 520 further incudes determining whether a valid period of the function is overdue. When it is overdue, it doesn't make use of the function to produce the modified pressure value.

In another embodiment, the method could include the similar function step in step 380. A function related to the stylus is generated based on the pressure signal value range and a standard pressure value range.

According to one embodiment of the present invention, a method for adjusting pressure signal parameter of stylus is provided. The method includes receiving a plurality of pressure signal values with regard to a stylus, determining a lower bound value of a pressure signal value interval with regard to the stylus according to the plurality of pressure signal values, and determining an upper bound value of the pressure signal value interval according to the plurality of pressure signal values.

In one embodiment, the lower bound value is a minimum value in the plurality of pressure signal values, the upper bound value is a maximum value in the plurality of pressure signal values. In another embodiment, the lower bound value is a minimum value in the plurality of pressure signal values related to a first detecting period, the upper bound value is a maximum value in the plurality of pressure signal values related to a second detecting period, wherein the first detecting period does not overlap the second detecting period. In still another embodiment, the lower bound value is an average value of the plurality of pressure signal values related to a first detecting period, the upper bound value is an average value of the plurality of pressure signal values related to a second detecting period, wherein the first detecting period does not overlap the second detecting period.

In one embodiment, the above-mentioned method further includes generating the plurality of the pressure signal values by the stylus.

In one embodiment, the above-mentioned method further includes determining whether the pressure signal value interval exists, performing a receiving step, a determining the lower bound value step, and a determining the upper bound value step when the pressure signal value interval does not exist. In another embodiment, the above-mentioned method further includes determining whether a valid period of the pressure signal value interval is overdue when the pressure signal value interval exists, and performing the receiving step, the determining the lower bound value step, the determining the upper bound value step, and renewing the valid period when the valid period is overdue.

In one embodiment, the above-mentioned method further includes generating a function related to the stylus according to the pressure signal value interval and a pressure value interval. In another embodiment, the above-mentioned method further includes determining whether the function exists, performing the receiving step, the determining the lower bound value step, the determining the upper bound value step, and generating the function step when the function does not exist. In still another embodiment, the above-mentioned method further includes determining whether a valid period of the function is overdue when the function exists, and performing the receiving step, the determining the lower bound value step, the determining the upper bound value step, the function generating step, and renewing the valid period when the valid period is overdue.

In one embodiment, the above-mentioned method further includes prompting a user using the stylus before the first detecting period, and prompting the user using the stylus before the second detecting period.

According to one embodiment of the present invention, a touch sensitive electronics for adjusting pressure signal parameter of stylus is provided. The touch sensitive electronics includes a receiving interface used to receive a plurality of pressure signal values with regard to a stylus, and a processor used to determine a lower bound value of a pressure signal value interval with regard to the stylus according to the plurality of pressure signal vales and determine an upper bound value of the pressure signal value interval according to the plurality of pressure signal values.

In one embodiment, the lower bound value is a minimum value in the plurality of pressure signal values, the upper bound value is a maximum value in the plurality of pressure signal values. In another embodiment, the lower bound value is a minimum value in the plurality of pressure signal values related to a first detecting period, the upper bound value is a maximum value in the plurality of pressure signal values related to a second detecting period, wherein the first detecting period does not overlap the second detecting period. In still another embodiment, the lower bound value is an average value of the plurality of pressure signal values related to a first detecting period, the upper bound value is an average value of the plurality of pressure signal values related to a second detecting period, wherein the first detecting period does not overlap the second detecting period.

In one embodiment, the processor is further used to determine whether the pressure signal value interval exists, make the receiving interface receive a plurality of pressure signal values with regard to a stylus, determine a lower bound value of a pressure signal value interval with regard to the stylus according to the plurality of pressure signal values, and determine an upper bound value of the pressure signal value interval according to the plurality of pressure signal values when the pressure signal value interval does not exist. In another embodiment, the processor is further used to determine whether a valid period of the pressure signal value interval is overdue when the pressure signal value interval exists, make the receiving interface receive a plurality of pressure signal values with regard to a stylus, determine the lower bound value and the upper bound value and renew the valid period when the valid period is overdue.

In one embodiment, the processor is further used to generate a function related to the stylus according to the pressure signal value interval and a pressure value interval. In another embodiment, the processor is further used to determine whether the function exists, make the receiving interface receive a plurality of pressure signal values with regard to a stylus when the function does not exist, determine the lower bound value and the upper bound value according to the plurality of pressure signal values, and generate the function according to the pressure signal value interval and a pressure value interval. In still another embodiment, the processor is further used to determine whether a valid period of the function is overdue when the function exists, make the receiving interface receive a plurality of pressure signal values with regard to a stylus when the valid period is overdue, determine the lower bound value and the upper bound value according to the plurality of pressure signal values, generate the function according to the pressure signal value interval and a pressure value interval, and renew the valid period.

In one embodiment, the receiving interface includes one of the following: a touch screen, a wireless communication interface, and a wire communication interface.

In one embodiment, the touch sensitive electronics further includes a touch screen used to prompt a user using the stylus before the first detecting period, and prompt the user using the stylus before the second detecting period

According to one embodiment of the present invention, a touch sensitive electronic system is provided. The touch sensitive electronic system includes a stylus used to generate a plurality of pressure signal values, and a touch sensitive electronics, which includes a receiving interface used to receive the plurality of pressure signal values, and a processor used to determine a lower bound value of a pressure signal value interval with regard to the stylus according to the plurality of pressure signal values, and determine an upper bound value of the pressure signal value interval according to the plurality of pressure signal values.

According to the method, the touch sensitive electronics, and the system for adjusting pressure signal parameter of stylus offered by each embodiment in the present invention, the pressure signal value interval related to individual stylus can be set up. According to the pressure signal value interval and standard pressure interval, a modified function can be produced. By corresponding to the modified function of individual stylus and based on the actual pressure strength of the stylus, the modified pressure value can be precisely generated to change the writing effects displayed on the touch sensitive screen.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A method for adjusting pressure signal parameter of stylus, comprising:
receiving a plurality of pressure signal values with regard to a stylus;
determining a lower bound value of a pressure signal value interval with regard to the stylus according to the plurality of pressure signal values; and
determining an upper bound value of the pressure signal value interval according to the plurality of pressure signal values.

2. The method of claim 1, wherein the lower bound value is a minimum value in the plurality of pressure signal values, the upper bound value is a maximum value in the plurality of pressure signal values.

3. The method of claim 1, wherein the lower bound value is a minimum value in the plurality of pressure signal values related to a first detecting period, the upper bound value is a maximum value in the plurality of pressure signal values related to a second detecting period, the first detecting period does not overlap the second detecting period.

4. The method of claim 1, wherein the lower bound value is an average value of the plurality of pressure signal values related to a first detecting period, the upper bound value is an average value of the plurality of pressure signal values related to a second detecting period, the first detecting period does not overlap the second detecting period.

5. The method of claim 1, further comprising:
generating the plurality of pressure signal values by the stylus.

6. The method of claim 1, further comprising:
determining whether the pressure signal value interval exists, performing a receiving step, a determining the lower bound value step, and a determining the upper bound value step when the pressure signal value interval does not exist.

7. The method of claim 6, further comprising:
determining whether a valid period of the pressure signal value interval is overdue when the pressure signal value interval exists, and performing the receiving step, the determining the lower bound value step, the determining the upper bound value step, and renewing the valid period when the valid period is overdue.

8. The method of claim 1, further comprising:
generating a function related to the stylus according to the pressure signal value interval and a pressure value interval.

9. The method of claim 8, further comprising:
determining whether the function exists, performing the receiving step, the determining the lower bound value step, the determining the upper bound value step, and generating the function step when the function does not exist.

10. The method of claim 9, further comprising:
determining whether a valid period of the function is overdue when the function exists, and performing the receiving step, the determining the lower bound value step, the determining the upper bound value step, the function generating step, and renewing the valid period when the valid period is overdue.

11. The method of claim 3, further comprising:
prompting a user using the stylus before the first detecting period; and
prompting the user using the stylus before the second detecting period.

12. The method of claim 4, further comprising:
prompting a user using the stylus before the first detecting period; and
prompting the user using the stylus before the second detecting period.

13. A touch sensitive electronics for adjusting pressure signal parameter of stylus, comprising:
a receiving interface, used to receive a plurality of pressure signal values with regard to a stylus; and
a processor, used to determine a lower bound value of a pressure signal value interval with regard to the stylus according to the plurality of pressure signal values; and determine an upper bound value of the pressure signal value interval according to the plurality of pressure signal values.

14. The touch sensitive electronics of claim 13, wherein the lower bound value is a minimum value in the plurality of pressure signal values, the upper bound value is a maximum value in the plurality of pressure signal values.

15. The touch sensitive electronics of claim 13, wherein the lower bound value is a minimum value in the plurality of pressure signal values related to a first detecting period, the upper bound value is a maximum value in the plurality of pressure signal values related to a second detecting period, the first detecting period does not overlap the second detecting period.

16. The touch sensitive electronics of claim 13, wherein the lower bound value is an average value of the plurality of pressure signal values related to a first detecting period, the upper bound value is an average value of the plurality of pressure signal values related to a second detecting period, the first detecting period does not overlap the second detecting period.

17. The touch sensitive electronics of claim 13, wherein the processor is further used to determine whether the pressure signal value interval exists, make the receiving interface receive a plurality of pressure signal values with regard to a stylus, determine a lower bound value of a pressure signal value interval with regard to the stylus according to the plurality of pressure signal values, and determine an upper bound value of the pressure signal value interval according to the plurality of pressure signal values.

18. The touch sensitive electronics of claim 17, wherein the processor is further used to determine whether a valid period of the pressure signal value interval is overdue when the pressure signal value interval exists, make the receiving interface receive a plurality of pressure signal values with regard to a stylus, determine the lower bound value and the upper bound value and renew the valid period when the valid period is overdue.

19. The touch sensitive electronics of claim 13, wherein the processor is further used to generate a function related to the stylus according to the pressure signal value interval and a pressure value interval.

20. The touch sensitive electronics of claim 19, wherein the processor is further used to determines whether the function exists, make the receiving interface receive a plurality of pressure signal values with regard to a stylus when the function does not exist, determine the lower bound value and the upper bound value according to the plurality of pressure signal values, and generate the function according to the pressure signal value interval and a pressure value interval.

21. The touch sensitive electronics of claim 20, wherein the processor is further used to determine whether a valid period of the function is overdue when the function exists, make the receiving interface receive a plurality of pressure signal values with regard to a stylus when the valid period id overdue, determine the lower bound value and the upper bound value according to the plurality of pressure signal values, generate the function according to the pressure signal value interval and a pressure value interval, and renew the valid period.

22. The touch sensitive electronics of claim 13, wherein the receiving interface includes one of the following:
a touch screen;
a wireless communication interface; and
a wire communication interface.

23. The touch sensitive electronics of claim 15, further comprising a touch screen used to prompt a user using the stylus before the first detecting period, and prompt the user using the stylus before the second detecting period.

24. The touch sensitive electronics of claim 16, further comprising a touch screen used to prompt a user using the stylus before the first detecting period, and prompt the user using the stylus before the second detecting period.

25. A touch sensitive electronic system, comprising:
a stylus, used to generate a plurality of pressure signal values; and
a touch sensitive electronics, comprising:
a receiving interface, used to receive the plurality of pressure signal values; and
a processor, used to determine a lower bound value of a pressure signal value interval with regard to the stylus according to the plurality of pressure signal values, and determine an upper bound value of the pressure signal value interval according to the plurality of pressure signal values.
